(19) United States
(12) Patent Application Publication
(10) Pub. No.: US 2013/0128113 A1
(43) Pub. Date: May 23, 2013

(54) TRANSMISSION SCHEDULING METHOD

(71) Applicants: Seok Ho Won, Daejeon (KR); Ho Kyom Kim, Daejeon (KR); Sun Hyoung Kwon, Daejeon (KR); Jong Soo Lim, Daejeon (KR); Jin Woo Hong, Daejeon (KR)

(72) Inventors: Seok Ho Won, Daejeon (KR); Ho Kyom Kim, Daejeon (KR); Sun Hyoung Kwon, Daejeon (KR); Jong Soo Lim, Daejeon (KR); Jin Woo Hong, Daejeon (KR)

(73) Assignee: Electronics and Telecommunications Research Institute, Daejeon (KR)

(21) Appl. No.: 13/813,139

(22) PCT Filed: Jul. 28, 2011
(86) PCT No.: PCT/KR2011/005555

§ 371 Date: Jan. 29, 2013

(30) Foreign Application Priority Data
Jul. 29, 2010 (KR) 10-2010-0073508
May 12, 2011 (KR) 10-2011-0044421

(51) Int. Cl. H04N 7/26; H04W 72/04; H04N 7/08; H04B 1/38

(52) U.S. Cl. CPC H04N 7/26228; H04B 1/38; H04W 72/044; H04N 7/08
USPC 348/473; 375/219; 370/329; 375/240.02

(57) ABSTRACT

Provided is a data transmission system using a vertical layer optimisation technique. A data transmission device predicts the buffer state of a data receiving device by using feedback information of a physical layer, and controls data transmission by referring to the predicted buffer state. The data transmission device can control the transmission of first data and second data such that the buffer state of the receiving device is within a preset range.

### TECHNICAL FIELD

The present invention relates to a method of transmitting data, and more particularly to a method of efficiently transmitting data based on a state of a channel.

### BACKGROUND ART

When a state of a wireless channel from a data transmitter to a data receiver is relatively excellent, data transmitted from the data transmitter may not have an error. Thus, the data receiver may receive and reproduce a video image transmitted from the data transmitter. However, the state of the wireless channel from the data transmitter to the data receiver may vary over time. When the state of the wireless channel is relatively poor, data transmitted from the data transmitter may have an error, and the data receiver may not receive and reproduce a video image.

To handle this, a scalable video coding (SVC) scheme has been introduced. According to the SVC scheme, a video image may be encoded in a base layer image and an enhancement layer image. The data receiver may receive both of the base layer image and the enhancement layer image, and reproduce a video image having an relatively excellent quality when the state of the wireless channel is relatively excellent, and may only receive the base layer image, and reproduce a video image when the state of the wireless channel is relatively poor.

### DISCLOSURE OF INVENTION

### Technical Goals

An aspect of the present invention provides a method of transmitting data that may maximize a service quality and a user capacity by efficiently using wireless resources.

Another aspect of the present invention provides a method of transmitting data that may enhance system efficiency by rapidly handling a change of a wireless channel using various types of information such as a state of the wireless channel, a scheduling, and the like.

### Technical Solutions

According to an aspect of the present invention, there is provided an operational method of a data receiver, the operational method including estimating a state of a channel from a data transmitter to the data receiver, setting, based on the state of the channel, an optimal state for a plurality of buffers in which each of a plurality of data, transmitted from the data transmitter, is buffered, and controlling transmission of each of the plurality of data, based on the state of the channel, so that the plurality of buffers maintain the optimal state.

According to another aspect of the present invention, there is provided an operational method of a data transmitter, the operational method including receiving, from a data receiver, a state of a channel from the data transmitter to the data receiver, estimating, based on the state of the channel, a state of a buffer of the data receiver in which each of a plurality of data, transmitted from the data transmitter to the data receiver, is buffered, and controlling transmission of the plurality of data based on the estimated state of the buffer.

According to still another aspect of the present invention, there is provided an operational method of a data receiver, the operational method including receiving, from a data transmitter, a base layer image and an enhancement layer image generated by encoding a video image using a scalable video coding (SVC) scheme, buffering the base layer image in a first buffer, and buffering the enhancement layer image in a second buffer, estimating a state of a channel from the data transmitter to the data receiver, and controlling a state of the first and second buffers based on the state of the channel.

### Effect of the Invention

According to an aspect of the present invention, there is provided a method of transmitting data that may maximize a service quality and a user capacity by efficiently using wireless resources.

According to another aspect of the present invention, it is possible to enhance system efficiency by rapidly handling a change of a wireless channel using various types of information such as a state of the wireless channel, a scheduling, and the like.

### BRIEF DESCRIPTION OF DRAWINGS

FIG. 1 is a diagram illustrating a concept of a data transmission system that transmits data based on information fed back from a data receiver according to embodiments of the present invention.

FIG. 2 is a diagram illustrating a plurality of buffers of a data receiver according to embodiments of the present invention.

FIG. 3 is a diagram illustrating a concept of a data transmission system that transmits data according to a state of a wireless channel according to embodiments of the present invention.

FIG. 4 is a flowchart illustrating a method of receiving data according to embodiments of the present invention.

FIG. 5 is a flowchart illustrating a method of transmitting data according to embodiments of the present invention.

FIG. 6 is a flowchart illustrating a method of receiving data according to embodiments of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

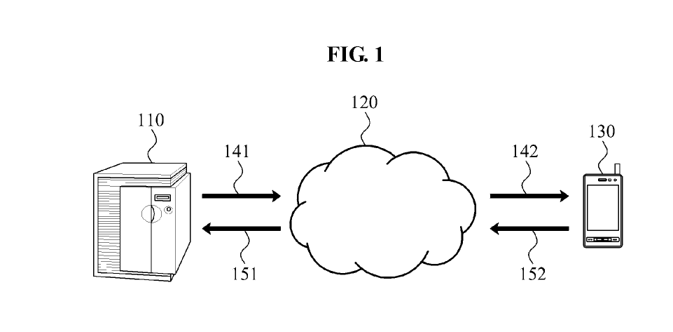

FIG. 1 is a diagram illustrating a concept of a data transmission system that transmits data based on information fed back from a data receiver according to embodiments of the present invention.

Referring to FIG. 1, a data transmitter 110 may transmit a plurality of data to a wireless communication network 120. A data receiver 130 may receive the plurality of data from the wireless communication network 120. According to embodiments of the present invention, the plurality of data transmitted by the data transmitter 110 may correspond to data for reproducing the same image. The plurality of data may be classified into first data including basic information for separately reproducing the corresponding image and second data including quality information for enhancing a quality of the corresponding image.

That is, the data receiver 130 may reproduce the corresponding image by merely using the basic information. However, the quality information may be used to enhance a quality of the corresponding image.

When a channel quality of the wireless network 120 is relatively excellent, both of the basic information and the quality information may be transmitted to the data receiver 130 using a bandwidth of the wireless network 120. In this instance, the data receiver 130 may receive both the basic information and the quality information, and reproduce the corresponding image with an enhanced quality.

However, when a channel quality of the wireless network 120 is relatively poor, both the basic information and the quality information may not be transmitted using the bandwidth of the wireless network 120. The data transmitter 110 may select one of the basic information and the quality information, and transmit the selected information using the bandwidth of the wireless network 120. In this instance, the data receiver 130 may reproduce the corresponding image by merely receiving the basic information.

The data receiver 130 may include a plurality of buffers to buffer first data in a first buffer, and buffer second data in a second buffer. When the channel quality of the wireless network 120 is relatively poor, the data receiver 130 may feed back, to the data transmitter 110, information about a state of the wireless network 120 or a state of each buffer.

The data transmitter 110 may initially transmit the basic information according to the state of the wireless network 120 or the state of each buffer. Since the state of the wireless network 120 or the state of each buffer may vary over time, transmission of the basic information and the quality information may be controlled according to the state of the wireless network 120 or the state of each buffer, thereby efficiently transmitting image information using limited wireless resources.

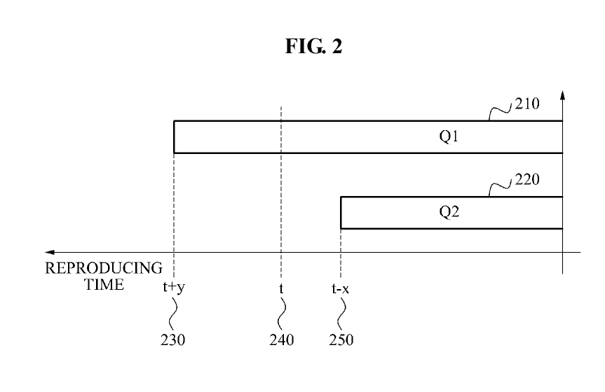

FIG. 2 is a diagram illustrating a plurality of buffers of a data receiver according to embodiments of the present invention.

A horizontal axis indicates a reproducing time of data buffered in each buffer. For example, a first buffer 210 may include a basic image, and a second buffer 220 may include a quality image. In this instance, the basic image stored in the first buffer 210 may correspond to a quantity to be reproduced for a time period t+y 230. The quality image stored in the second buffer 220 may correspond to a quantity to be reproduced for a time period t−x 250.

A data receiver may control transmission of the basic image and the quality image, respectively based on a remaining reproducing time of an image buffered in each of the first buffer 210 and the second buffer 220. For example, when a reproducing time of the buffered basic image decreases to be less than the time period t+y 230, the data receiver may transmit, to a data transmitter, a request for initially transmitting the basic image. However, when a reproducing time of the buffered quality image decreases to be less than the time period t−x 250, the data receiver may transmit, to the data transmitter, a request for initially transmitting the quality image.

According to embodiments of the present invention, the data receiver may estimate a state of a channel from the data transmitter to the data receiver, and may determine values of x and y according to the estimated state of the channel. The data receiver may determine the values of x and y to be “0,” respectively when the state of the channel is excellent. In this instance, reproducing times of images buffered in the first buffer 210 and the second buffer 220 may remain the same.

According to embodiments of the present invention, when the state of the channel is poor, the data receiver may determine the value of x or the value of y to be a value greater than “0.” In this instance, a reproducing time of the basic information buffered in the first buffer 210 may have a value greater than a reproducing time of the quality image buffered in the second buffer 220. That is, in this instance, the data receiver may initially receive the basic information.

According to embodiments of the present invention, the data transmitter may estimate, using a cross layer optimization (CLO) scheme, a state of a buffer of the data receiver. That is, the data transmitter may estimate, using channel state information (CSI) of a physical layer, the state of the buffer of the data receiver. Accordingly, the data transmitter may not receive the state of the buffer from the data receiver, or may accurately estimate the state of the buffer, and transmit the basic information or the quality information according to the estimated state of the buffer even when a reception period increases.

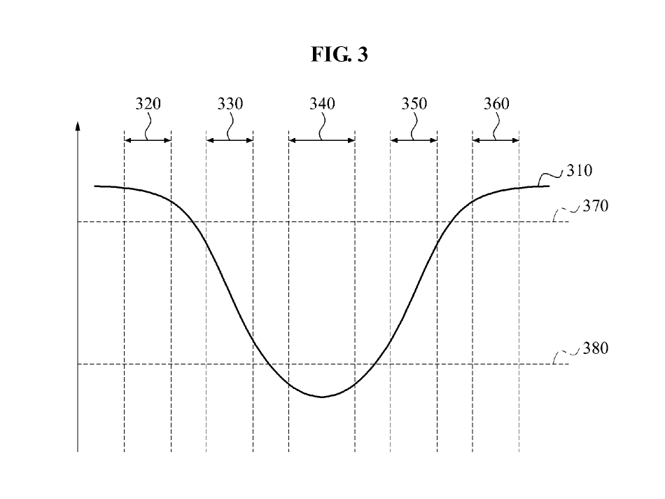

FIG. 3 is a diagram illustrating a concept of a data transmission system that transmits data according to a state of a wireless channel according to embodiments of the present invention.

A fading phenomenon of a wireless channel may be classified into a short term fading in which a size of a channel changes by several tens of decibels (dB) during several milliseconds (ms) and a long term fading in which a size of a channel changes by several dB during several tens or several hundreds of ms. According to embodiments of the present invention, a data transmitter may estimate, using a CLO scheme, a data transmission failure due to the long term fading, and may estimate a state of a buffer of a data receiver.

The data transmitter may receive, from the data receiver, information about a channel state. FIG. 3 illustrates a long term fading of a channel. A first section 320 of FIG. 3 may correspond to a state in which information about a channel state exceeds a first threshold value 370, which indicates an excellent channel state. In the first m section 320, a bandwidth of a channel may be sufficient for transmitting basic information and quality information, and the data receiver may control so that a reproducing time of basic information buffered in a first buffer equals a reproducing time of quality information buffered in a second buffer.

That is, as shown in Equation 1, when a ratio of a time period for reproducing the quality information buffered in a second buffer to a time period for reproducing the basic information buffered in a first buffer is presumed to be a value “a,” the data receiver may be controlled so that an equality a=1 is satisfied in the first section 320.

a=(t−x/(t+y) [Equation 1]

In Equation 1, t−x corresponds to a time period for reproducing the quality information buffered in the second buffer illustrated in FIG. 2, and t+y corresponds to a time period for reproducing the basic information buffered in the first buffer illustrated in FIG. 2.

A second section 330 may correspond to a section in which a channel state rapidly deteriorates. For example, when the data receiver moves to a rear of a building, a channel state may rapidly deteriorate as the second section 330. The data receiver may initially transmit the basic information so as to increase an amount of the basic information buffered in the first buffer, thereby preparing for a call outage.

According to embodiments of the present invention, the data receiver may mainly transmit a base network abstract layer (B-NAL) including the basic information. B-NAL data may be sufficiently stored in a video display buffer of the data receiver to prepare for the call outage.

When a channel state falls below a second threshold value 380, the data receiver may determine that the channel state significantly deteriorates. A third section 340 may correspond to an instance in which the channel state deteriorates, and a bandwidth of a channel is insufficient for transmitting both of the basic information and the quality information. According to embodiments of the present invention, the data receiver may initially receive the basic information to reproduce a minimal image. In this instance, the data receiver may be controlled so that an inequality a<<1 may be satisfied.

The call outage may occur in the third section 340. Since the basic information buffered in the first buffer is reproduced during the call outage, the first buffer may nearly reach an underflow state over time. Thus, the data receiver may attempt to initially receive the B-NAL during the call outage so as to prevent an underflow of the first buffer.

According to embodiments of the present invention, the data transmitter may estimate a buffer state of the data receiver. To prevent an estimation error of the data transmitter, the data receiver may simplify the buffer state as well as sufficiently and intermittently inform the data transmitter about the buffer state.

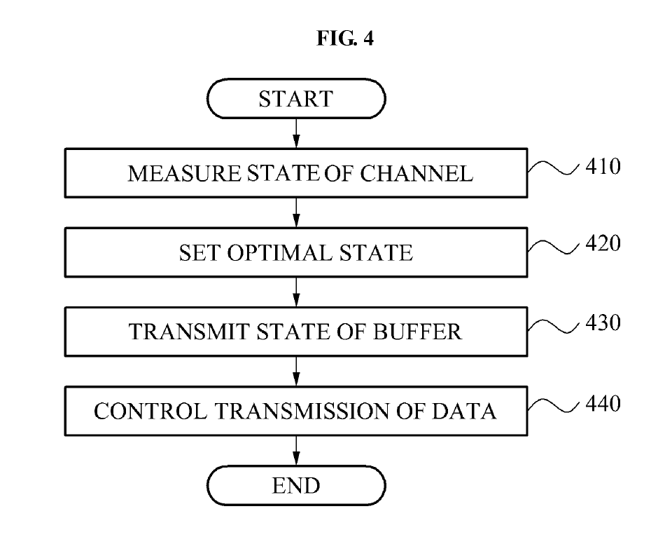

FIG. 4 is a flowchart illustrating a method of receiving data according to embodiments of the present invention.

In operation 410, a data receiver may estimate a state of a channel from a data transmitter to the data receiver. According to embodiments of the present invention, the data transmitter may transmit, to the data receiver, a pilot signal or a reference signal, and the data receiver may estimate, using the pilot signal or the reference signal, the state of the channel from the data transmitter to the data receiver. According to embodiments of the present invention, the state of a channel estimated in operation 410 may correspond to a channel quality indicator (CQI) value of the channel.

In operation 420, the data receiver may set, based on the state of the channel estimated in operation 410, an optimal state for a plurality of buffers in which each of a plurality of data, transmitted from the data transmitter, is buffered. According to embodiments of the present invention, each of the plurality of data received, from the data transmitter, by the data receiver may include image information. According to embodiments of the present invention, first data included in the plurality of data may have basic information for reproducing a video image. The basic information may correspond to information for separately reproducing the video image, and may involve a poor image quality when the video image is reproduced only using the basic information. Second data included in the plurality of data may have quality information for enhancing a quality of a video image. The quality information may not separately reproduce the video image, and may correspond to information for greatly enhancing an image quality when reproducing the video image with a basic image.

According to embodiments of the present invention, in operation 420, the data receiver may buffer the first data in a first buffer, and buffer the second data in a second buffer. According to embodiments of the present invention, the data receiver may control a ratio of receiving the first data to the second data based on a channel state. For example, the data receiver may receive the first data and the second data in similar proportions when the channel state is relatively excellent, and may only receive the first data when the channel state is relatively poor.

When the first data and the second data are received in different proportions, a time period for reproducing the first data buffered in the first buffer may be different from a time period for reproducing the second data buffered in the second buffer. Here, a time period for reproducing data buffered in each buffer may be understood as a time period for a remaining video image to be reproduced using data buffered in each buffer.

According to embodiments of the present invention, the optimal state set in operation 420 may correspond to a state in which a ratio of a time period for reproducing the quality information buffered in the second buffer to a time period for reproducing the basic information buffered in the first buffer is maintained to be within a predetermined range.

According to embodiments of the present invention, in operation 420, the data receiver may control, to be greater than or equal to a first threshold value, the ratio of a time period for reproducing the quality information buffered in the second buffer to a time period for reproducing the basic information buffered in the first buffer.

The ratio of a time period for reproducing the quality information to a time period for reproducing the basic information may be defined as shown in Equation 1 described in the foregoing. According to embodiments of the present invention, when the channel state is relatively excellent, the data receiver may set the value “a,” defined in Equation 1, to a value greater than or equal to the first threshold value that is similar to “1.”

According to embodiments of the present invention, when the channel state is relatively poor, the data receiver may set the value “a,” defined in Equation 1, to a value less than or equal to a second threshold value that is similar to “0.”

Here, when the channel state corresponds to a value less than or equal to a predetermined threshold channel value, the data receiver may determine that the channel state is relatively poor. That is, when the channel state corresponds to a value less than or equal to a predetermined threshold channel value, the data receiver may initially receive the first data including the basic information so as to maintain the value “a” defined in Equation 1 to a value similar to “0.”

According to embodiments of the present invention, in operation 420, the data receiver may set the optimal state additionally based on scheduling information of a media access control (MAC) layer.

In operation 430, the data receiver may transmit the estimated state of a channel to the data transmitter. The state of a channel transmitted to the data transmitter may be used for the data transmitter to estimate a channel state of the data receiver. The data receiver may estimate a buffer state, and may transmit the estimated buffer state to the data transmitter. The data transmitter may use the estimated buffer state to verify the estimation of the buffer state performed by the data transmitter, and to enhance an accuracy of the estimation. When the estimation of the buffer state is relatively accurate, the data receiver may transmit the estimated buffer state at relatively long intervals, or may not transmit the estimated buffer state.

In operation 440, the data receiver may control, based on the estimated channel state, transmission of data so that the plurality of buffers may maintain the optimal state. According to embodiments of the present invention, depending on channel states, the ratio of a time period for reproducing the quality information buffered in the second buffer to a time period for reproducing the basic information buffered in the first buffer may depart from the optimal state set in operation 420. In this instance, by requesting an initial transmission of predetermined information, the data receiver may control transmission of each data so that the ratio of a time period for reproducing the quality information buffered in the second buffer to a time period for reproducing the basic information buffered in the first buffer may return to the optimal state.

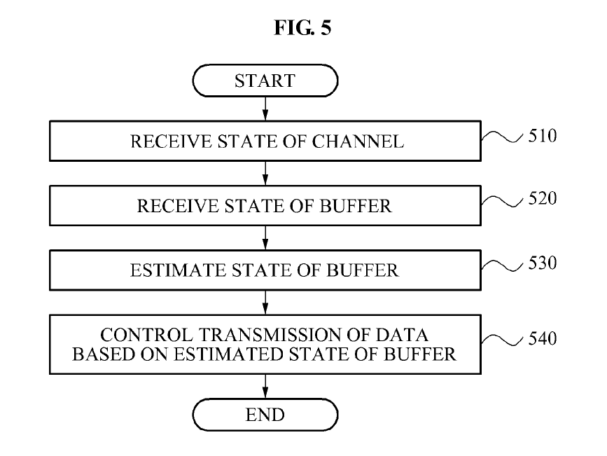

FIG. 5 is a flowchart illustrating a method of transmitting data according to embodiments of the present invention.

In operation 510, a data transmitter may receive, from a data receiver, a state of a channel from the data transmitter to the data receiver. According to embodiments of the present invention, the state of a channel received by the data transmitter may correspond to a CQI value of the channel from the data transmitter to the data receiver.

In operation 520, the data transmitter may receive, from the data receiver, a buffer state of the data receiver.

In operation 530, the data transmitter may estimate, based on the state of a channel, states of a plurality of buffers of the data receiver. The data transmitter may transmit, to the data receiver, each of a plurality of data, and the data receiver may buffer each of the plurality of data in a buffer that corresponds to each of data. According to embodiments of the present invention, the plurality of data may include first data that includes basic information for reproducing a video image and second data that includes quality information for enhancing a quality of the video image. Here, the buffer state may indicate a time period for reproducing data buffered in each buffer.

According to embodiments of the present invention, the data transmitter may estimate, using a cross layer optimization, the buffer state from the state of a channel. For example, the data transmitter may estimate a state of each buffer based on a transfer rate of transmission and reception, an error generation rate, and the like. According to embodiments of the present invention, the data transmitter may estimate the buffer state of the data receiver additionally based on scheduling information of a MAC layer.

According to embodiments of the present invention, the data transmitter may estimate the buffer state in operation 530 based on the buffer state received from the data receiver in operation 520. The data transmitter may use the buffer state received from the data receiver to more accurately estimate the buffer state.

According to embodiments of the present invention, a bandwidth of a channel from the data receiver to the data transmitter may be limited. Thus, a feedback of the buffer state from the data receiver may not be performed in real time, or a relatively inaccurate value may be transmitted. When the buffer state is accurately estimated, the data transmitter may precisely perform a data transmission even when a relatively inaccurate value is transmitted.

According to embodiments of the present invention, the data transmitter may not receive the buffer state from the data receiver in operation 520, and may accurately estimate the buffer state in operation 530.

In operation 540, the data transmitter may control a transmission of data based on the estimated buffer state.

According to embodiments of the present invention, the data transmitter may control a transmission of each piece of information so that a ratio of a time period for reproducing the quality information buffered in the second buffer to a time period for reproducing the basic information buffered in the first buffer is included in a predetermined range.

According to embodiments of the present invention, the data transmitter may control a data transmission based on a channel state received from the data receiver. According to embodiments of the present invention, when the channel state is less than a predetermined threshold channel value, the data transmitter may determine that the state of the channel to the data receive is relatively poor. When a buffer state of the first buffer or the second buffer decreases to be less than or equal to a predetermined threshold value, the data transmitter may determine that the state of the channel to the data receive is relatively poor. In this instance, the data transmitter may control, to be a value greater than or equal to a first threshold value, a ratio of a time period for reproducing the quality information buffered in the second buffer to a time period for reproducing the basic information buffered in the first buffer.

According to embodiments of the present invention, when the state of the channel corresponds to a value greater than or equal to a predetermined threshold channel value, the data transmitter may determine that the state of the channel to the data receive is relatively excellent. In this instance, the data transmitter may control, to be a value less than or equal to a second threshold value, a ratio of a time period for reproducing the quality information buffered in the second buffer to a time period for reproducing the basic information buffered in the first buffer. That is, in this instance, the data transmitter may initially transmit the first data including the basic information so that a video image may be reproduced without being disconnected.

According to embodiments of the present invention, in a three-dimensional (3D) video image, left vision data may correspond to the basic information, and right vision data may correspond to the quality information. In this example, the opposite case may also be possible.

According to embodiments of the present invention, a base layer in an SVC scheme may correspond to the basic information, and an enhancement layer may correspond to the quality information.

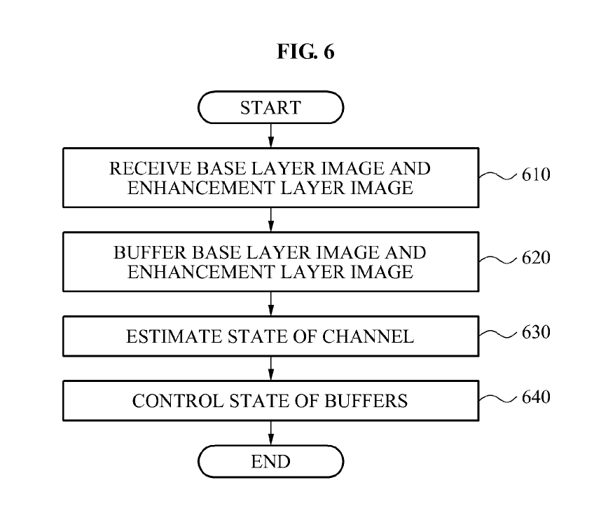

Hereinafter, an embodiment to which the present invention is applied to transmit a video image encoded using the SVC scheme will be described with reference to FIG. 6.

FIG. 6 is a flowchart illustrating a method of receiving data according to embodiments of the present invention.

In operation 610, a data receive may receive, from a data transmitter, a base layer image and an enhancement layer image. The base layer image and the enhancement layer image may correspond to images generated by encoding the same video image using an SVC scheme.

In operation 620, the data receiver may buffer the base layer image in a first buffer, and buffer the enhancement layer image in a second buffer.

In operation 630, the data receiver may estimate a state of a channel from the data transmitter to the data receiver.

In operation 640, the data receiver may control a state of the first and second buffers based on the state of the channel.

According to embodiments of the present invention, in operation 640, the data receiver may initially receive one of the base layer image and the enhancement layer image based on the state of the first and second buffers and the state of the channel.

According to embodiments of the present invention, when the state of the channel is relatively excellent, the data receiver may control, to be a value greater than or equal to a first threshold value, a ratio of a time period for reproducing the quality information buffered in the second buffer to a time period for reproducing the basic information buffered in the first buffer.

According to embodiments of the present invention, when the state of the channel is relatively poor, the data receiver may control, to be a value less than or equal to a second threshold value, a ratio of a time period for reproducing the quality information buffered in the second buffer to a time period for reproducing the basic information buffered in the first buffer.

1. An operational method of a data receiver, the operational method comprising:
estimating a state of a channel from a data transmitter to the data receiver;
setting, based on the state of the channel, an optimal state for a plurality of buffers in which each of a plurality of data, transmitted from the data transmitter, is buffered; and
controlling transmission of each of the plurality of data, based on the state of the channel, so that the plurality of buffers maintain the optimal state.

2. The operational method of claim 1, wherein:
each of the plurality of data includes image information, and
the optimal state corresponds to a ratio of time periods during which image information included in data buffered in each buffer is reproduced.

3. The operational method of claim 1, wherein the plurality of data comprises first data that includes basic information for reproducing a video image and second data that includes quality information for enhancing a quality of the video image.

4. The operational method of claim 3, wherein, when the state of the channel corresponds to a value less than or equal to a predetermined threshold channel value, the controlling comprises initially receiving the first data.

5. The operational method of claim 4, wherein the controlling comprises controlling, to be a value greater than or equal to a first threshold value, a ratio of a time period for reproducing the quality information buffered in a second buffer among the plurality of buffers to a time period for reproducing the basic information buffered in a first buffer among the plurality of buffers.

6. The operational method of claim 3, wherein, when the state of the channel corresponds to a value greater than or equal to a predetermined threshold channel value, the controlling comprises controlling, to be a value less than or equal to a second threshold value, a ratio of a time period for reproducing the quality information buffered in a second buffer among the plurality of buffers to a time period for reproducing the basic information buffered in a first buffer among the plurality of buffers.

7. The operational method of claim 1, wherein the setting comprises setting the optimal state additionally based on scheduling information of a media access control (MAC) layer.

8. The operational method of claim 1, further comprising:
estimating states of the plurality of buffers, and transmitting, to the data transmitter, the estimated states of the plurality of buffers,
wherein the controlling comprises controlling transmission of each of the plurality of data with reference to the transmitted states of the plurality of buffers.

9. An operational method of a data transmitter, the operational method comprising:
receiving, from a data receiver, a state of a channel from the data transmitter to the data receiver;
estimating, based on the state of the channel, a state of a buffer of the data receiver in which each of a plurality of data, transmitted from the data transmitter to the data receiver, is buffered; and
controlling transmission of the plurality of data based on the estimated state of the buffer.

10. The operational method of claim 9, wherein the estimating comprises estimating the state of the buffer additionally based on scheduling information of a media access control (MAC) layer.

11. The operational method of claim 9, further comprising:
receiving the state of the buffer from the data receiver,
wherein the estimating comprises estimating the state of the buffer based on the received state of the buffer.

12. The operational method of claim 9, wherein the plurality of data comprises first data that includes basic information for reproducing a video image and second data that includes quality information for enhancing a quality of the video image.

13. The operational method of claim 12, wherein the controlling comprises controlling, to be a value greater than or equal to a first threshold value, a ratio of a time period for reproducing the quality information buffered in a second buffer among the plurality of buffers to a time period for reproducing the basic information buffered in a first buffer among the plurality of buffers.

14. The operational method of claim 12, wherein, when the state of the channel corresponds to a value greater than or equal to a predetermined threshold channel value, the controlling comprises controlling, to be a value less than or equal to a second threshold value, a ratio of a time period for reproducing the quality information buffered in a second buffer among the plurality of buffers to a time period for reproducing the basic information buffered in a first buffer among the plurality of buffers.

15. The operational method of claim 12, wherein, when the state of the channel corresponds to a value less than or equal to a predetermined threshold channel value, the controlling comprises initially receiving the first data.

16. An operational method of a data receiver, the operational method comprising:
receiving, from a data transmitter, a base layer image and an enhancement layer image generated by encoding a video image using a scalable video coding (SVC) scheme;
buffering the base layer image in a first buffer, and buffering the enhancement layer image in a second buffer;
estimating a state of a channel from the data transmitter to the data receiver; and
controlling a state of the first and second buffers based on the state of the channel.

17. The operational method of claim 16, wherein the controlling comprises initially receiving one of the base layer image and the enhancement layer image based on the state of the first and second buffers and the state of the channel.

18. The operation method of claim 16, wherein the controlling comprises controlling, to be a value greater than or equal to a first threshold value, a ratio of a time period for reproducing the quality information buffered in a second buffer among the plurality of buffers to a time period for reproducing the basic information buffered in a first buffer among the plurality of buffers.

19. The operation method of claim 16, wherein, when the state of the channel corresponds to a value greater than or equal to a predetermined threshold channel value, the controlling comprises controlling, to be a value less than or equal to a second threshold value, a ratio of a time period for reproducing the quality information buffered in a second buffer among the plurality of buffers to a time period for reproducing the basic information buffered in a first buffer among the plurality of buffers.
